(19) United States
(12) Patent Application Publication
(10) Pub. No.: US 2004/0190383 A1
(43) Pub. Date: Sep. 30, 2004

(54) Housing for electronic device wearable on user's finger

(75) Inventors: Kai Marcucelli, Littleton, MA (US); Craig Wojcieszak, Lee, NH (US); Edward C. Frederick, Brentwood, NH (US)

Correspondence Address: OBLON, SPIVAK, MCCLELLAND, MAIER & NEUSTADT, P.C., 1940 DUKE STREET, ALEXANDRIA, VA, 22314, US

(73) Assignee: Fila Luxembourg S.A.R.L., Luxembourg (LU)

(21) Appl. No.: 10/694,014

(22) Filed: Oct. 28, 2003

Related U.S. Application Data
(60) Provisional application No. 60/456,549, filed on Mar. 24, 2003.
(60) Provisional application No. 60/456,548, filed on Mar. 24, 2003.

(51) Int. Cl. G04B 37/00; G04B 37/12

(52) U.S. Cl. 368/278

(57) ABSTRACT

A housing including a sleeve portion having an interior bend configured to receive a knuckle on a wearer's finger such that the housing can be securely mounted on the wearer's finger. The housing also includes a cavity configured to receive an electronics module therein, and a control access configured to align with controls of the electronics module such that the wearer can operate the electronics module when contained in the recess. The housing may include an electronics module such a watch or medical monitoring device.

### CROSS-REFERENCE TO RELATED APPLICATIONS

This application claims priority to U.S. Provisional Application Serial No. 60/456,549, filed on Mar. 24, 2003. This application is related to U.S. Provisional Application Serial No. 60/456,548, filed on Mar. 24, 2003; and U.S. utility application entitled “PERSONAL ELECTRONIC DEVICE HAVING CUSTOM MODE SETTING FEATURE” filed Oct. 28, 2003 (Attorney Docket No. 244709US17). The contents of these applications are incorporated herein by reference.

### BACKGROUND OF THE INVENTION

1. Field of the Invention

The present invention is generally directed to wearable electronic devices, and more particularly directed to watches.

2. Discussion of the Background

Many devices such as watches medical monitoring devices etc. are mounted on a wrist band for convenient viewing and access by the user. These watches have many features that require operation of buttons on the device. For example, the user of a wrist watch may press a button on the watch to check the date, and alarm setting etc. Operation of such buttons requires the user to use fingers on the opposite hand that the wrist band is worn on to cross over the user's body and operate the buttons.

The present inventors studied the movements associated with operation of a conventional wrist device and discovered that using the opposing hand to operate the wrist device poses several problems. First, for handicapped individuals that have use of one arm, the conventional wrist device is impossible to operate. A more widespread problem exists for non-handicapped individuals that want to operate their wrist device while performing activities. Specifically, in order to operate the wrist device, the user must divert his attention and physical efforts from the activity to checking the feature of the electronic device. This may be inconvenient and, for sporting events, affect the athlete's performance.

U.S. Pat. No. 5,088,072 discloses a watch worn on the user's finger. However, the present inventors have determined that the device of the U.S. Pat. No. 5,088,072 patent uses crude attachment mechanisms that are uncomfortable and poorly suited for holding the watch in place. This causes problems for the athlete such as movement of the watch during activities.

### SUMMARY OF THE INVENTION

One object of the present invention is to solve or reduce the above-described or other problems in the art.

Another object of the present invention is to provide an electronic device such as a watch, medical monitoring device etc. that can be easily and effectively operated using the same hand it is worn on.

These and/or other objects of the invention are provided by a housing for an electronics module. The housing includes a sleeve portion having an interior bend configured to receive a knuckle on a wearer's finger such that the housing can be securely mounted on the wearer's finger, a cavity configured to receive an electronics module therein, and a control access configured to align with controls of the electronics module such that the wearer can operate the electronics module when contained in the recess. The housing may include an electronics module such a watch or medical monitoring device.

In another aspect of the invention, a housing for an electronics module includes means for receiving a knuckle on a wearer's finger such that the housing can be securely mounted on the wearer's finger, means for mounting an electronics module in the housing, and means for accessing controls of the electronics module such that the wearer can operate the electronics module when contained in the recess.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIGS. 1-7 show several views of a finger watch in accordance with one embodiment of the present invention;

FIG. 8 shows an embodiment of the present invention worn on a user's hand;

FIGS. 9A-9D show an alternative embodiment of the present invention implemented as a finger watch and worn on a user's hand;

FIGS. 10A- 10D show another embodiment of the present invention implemented as a device worn on the user's ring finger;

FIGS. 11A-11E show other embodiments of the present invention implemented as a device worn on adjacent fingers of the user's hand;

FIG. 12 is an electronic block diagram showing the architecture of an electronic device in accordance with one embodiment of the present invention;

FIG. 13 is a flow chart showing a general operation of an electronic device having the custom mode setting feature in accordance with an embodiment of the present invention;

FIG. 14 is a flow chart showing a conventional mode operation process for a digital watch in comparison to a process for setting custom modes in accordance with an embodiment of the present invention;

FIG. 15 is a process flow diagram showing the custom mode setting feature of the present invention according to another embodiment of the present invention; and

FIG. 16 is an exemplary display that may be used in an electronic device in accordance with the present invention.

### DESCRIPTION OF THE PREFERRED EMBODIMENTS

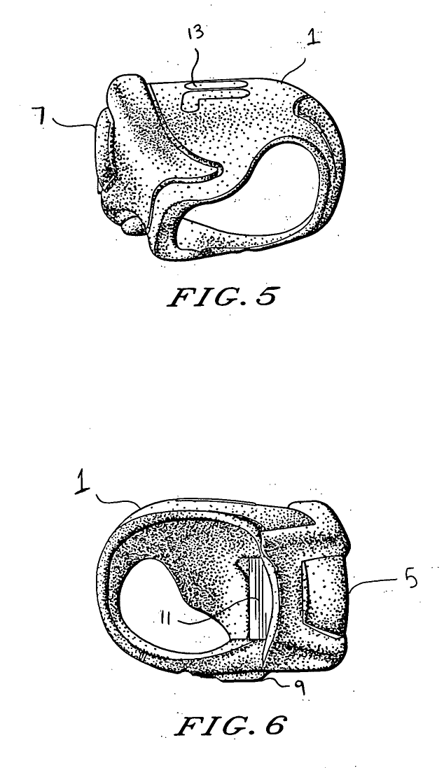

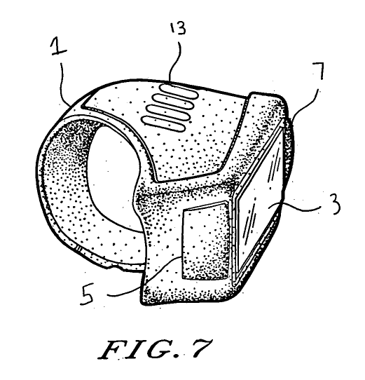

Referring now to the drawings, FIGS. 1-7 show an electronic device that can be worn on a user's finger in accordance with an embodiment of the present invention. FIGS. 1, 2, 3 and 4 show a front view, back view, top view, and bottom view of the device respectively. FIG. 5 shows a side view from direction A indicated in FIG. 1, and FIG. 6 shows a side view from direction B indicated in FIG. 1, while FIG. 7 shows a perspective view of the device. As seen in these figures, the electronic device that can be worn on a user's finger includes a housing 1 having operation buttons 5, 7 and 9, and an electronics module 11 having display 3.

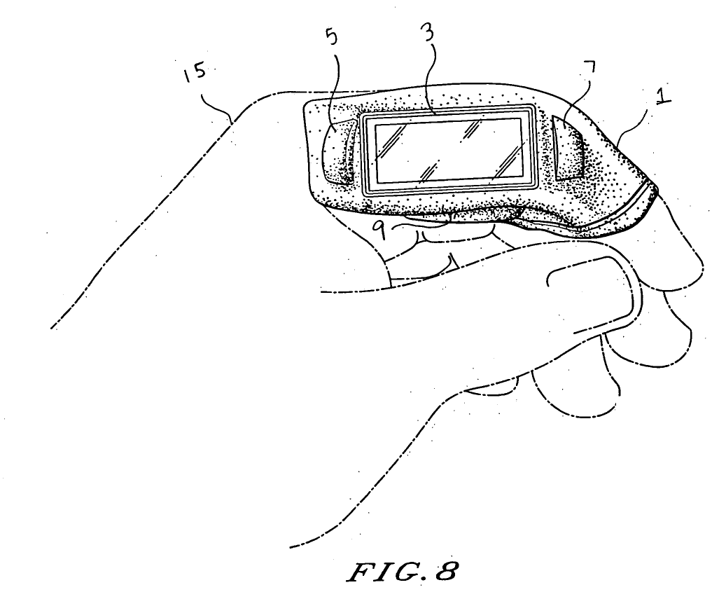

In the embodiment of FIGS. 1-7, the housing 1 is a molded sleeve having a tube-like interior that is bent or contoured to form an interior bend for receiving a knuckle of the user's finger. In one embodiment, the housing or sleeve 1 does not include separable parts and is not designed to be elastic enough for secure mounting of the device on the user's finger. Rather the housing 1 relies on the bend and the truncated conical shape of the user's finger (finger becomes smaller as you move distally) to provide a snug fit for a broad range of people. For example, one size sleeve 1 can fit over an ectomorphic man's proximal and medial finger segment, while also fitting over a mesomorphic man's medial and distal finger segments. Moreover, the shape of the housing 1 ensures that the housing 1 of the electronic device is only worn on a side of a medial aspect of the finger, which optimizes the viewing angle of the display 3. Conventional devices are generally worn on the top of the user's finger. The bent tubular shape also decreases the chance that the watch will rotate around the user's finger when the user presses one of the operation buttons 5, 7 or 9. Thus, secure mounting of the housing 1 on the user's finger is accomplished by the ergonomic design of the housing 1 including the bent truncated conical shape for receiving the user's knuckle as best seen in FIG. 8, which will be described below.

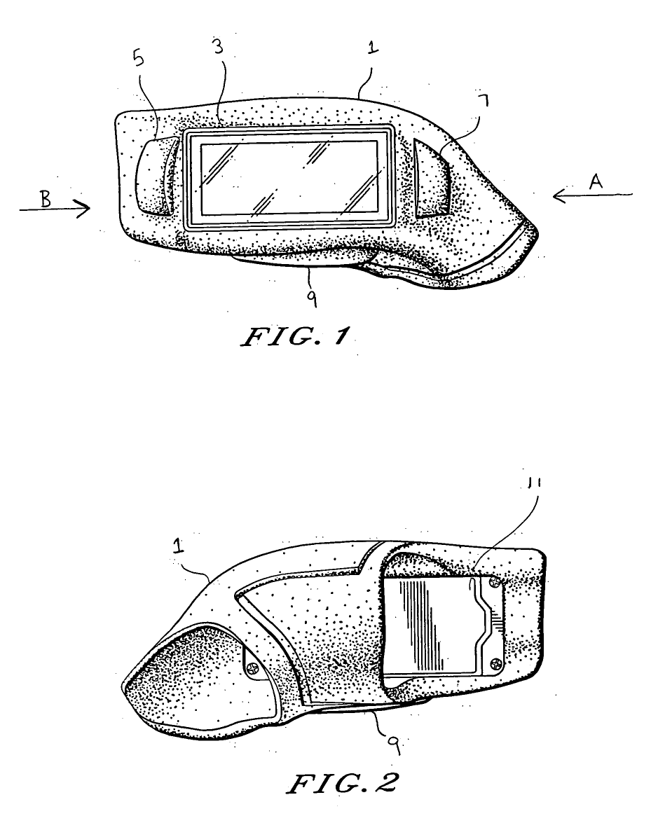

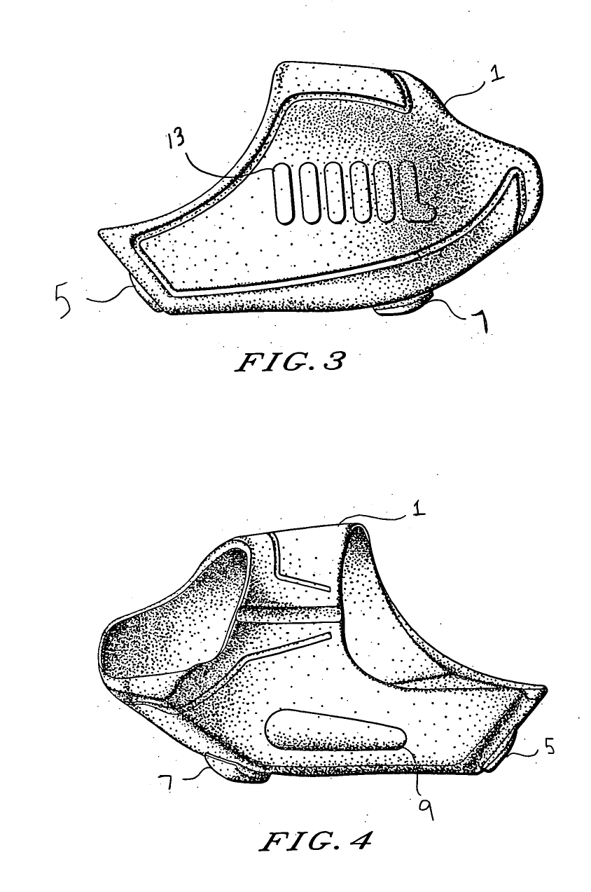

The housing 1 also includes a rectangular shaped cavity for receiving the similarly shaped electronics module 11, as best appreciated from FIGS. 2 and 6. The cavity includes openings to the front and rear (interior) of the housing 1, the openings being smaller than a periphery of the module 11 such that the module 11 is held securely in the sleeve 1 when the module 11 is forced into the cavity. The front opening is rectangular in shape and sized such that the display 3 of the electronic module 11 is viewable to the user when inserted in the housing 1.

In the embodiment of FIGS. 1-7, switch covers integral to the housing 1 are positioned on opposing sides of, and below, the display 3 so that the switch covers can be pressed by the user to activate similarly located switches on the electronics module 11, when the module 11 is in the housing 1. Thus, the switch covers of the housing form the operation buttons 5, 7, and 9 of the electronics device. The operation buttons 5, 7 and 9 are buttons that can be depressed by the user of the electronic device in order to operate the various functions available on the electronic device. While buttons are shown in FIGS. 1-7, switches, knobs or other suitable controls may be used. According to the embodiment of the invention shown in FIGS. 1-7, the operation buttons 5, 7 and 9 are uniquely placed to decrease changes of mistakenly pressing a button, and provide ergonomic advantages, particularly with placement of the buttons to the right and left of the display 3. The actual switches on the electronics module 11 (not shown) are depress switches mounted on planar surfaces of the electronics module and are sized so as to be significantly smaller than the length, width and height dimensions of the side on which the switch is mounted. That is, the switches are preferably located on a discrete portion of a surface of the module 11 and do not occupy the entire distance of any dimension of the respective mounting surface as can be appreciated from FIGS. 1-7.

The electronics module 11 can measure, record, and/or provide feedback regarding many phenomena. Examples of the phenomena include, but are not limited to: time, position (absolute—GPS describing location of individual, relative—position of one portion of anatomy to another), speed via GPS, air/water speed, direction, altitude, barometric pressure, heart rate, blood lactate levels, blood oxygenation, blood pressure, breathing rate, temperature (the wearer's body temp, environmental, specific location via probe or IR), sound, voice etc. The feedback could be communicated by visual, audible, or tactile (ex. Vibration) means. The electronics module can also have other functions; examples include, but are not limited to: transmitting or receiving a radio or infrared signal (e.g., remote control), flashlight, MP3 player, portable computer hard drive memory device, cell phone, digital camera/video camera, voice recorder, mini computer hard drive, personal digital assistant, rechargeable power source for other electronic devices, etc. Finally, the electronics module may include any of the features or functionality described with respect to FIGS. 12-16 below.

As seen in FIGS. 3, 5 and 7, the housing 1 can optionally include a logo imprinted thereon. In these figures, the logo is a registered trademark owned by Fila Sport S.P.A., however any desirable logo or text can be used. Moreover, in one embodiment, the rough overall dimensions of the device illustrated in FIGS. 1-7, when viewing the front face are 58 mm from left tip of watch to right tip, 22 mm from bottom of long thin button to top of watch, and 34 mm from front of the display to back of watch.

As seen in FIG. 8, the electronic device is worn so that the electronics module 11 (and the portion of the sleeve 1 that contains it) covers portions of two adjacent segments of the user's finger with the user's knuckle fitting snugly into the interior bend in the molded sleeve. The interior bend is positioned relative to the display portion such that the display is mounted on a side of the user's finger along the thickness or height of the user's finger when the device is worn by the user. The ergonomic design, including the bent truncated conical shape, of the sleeve prevents orientation of the display on top of the user's finger when properly worn.

Research conducted by the present inventors shows that typical watches have only one function, or are designed to require two hands to operate any additional functions. This shortcoming creates many difficulties for the wearer. The present inventors have discovered that the device of FIGS. 1-7 allows people to attach an electronic device to their hand, finger(s), or thumb and to easily operate the electronic device with the fingers or thumb of the same hand. In this context the attachment device is referred to herein as a “housing.” The housing is ergonomically and anatomically shaped to utilize the person's anatomy to keep the device in place without conscious effort. One exemplary feature that makes the inventive electronic device unique and advantageous over conventional wearable electronic device is the ergonomic shape of the wearable electronic device (self-securing, easy reading, unobtrusive, etc). One-handed operation and quick reading allows safer, more accurate time keeping and no rotation of armn or wrist is required for operation or reading of the device. In addition a user does not have to break stride while running, as required by two-handed operation. This allows safer and more accurate timing, as well as better performance.

Moreover, position of the display on a side portion of a medial aspect of index finger is optimal for visibility of the display. That is, the inventive device is easier to view display than conventional electronic device such as watches (less movement rotation and displacement of body parts required to read. Also the sleeve of a shirt or jacket will not cover the finger display, as it does frequently with wrist watches and other wrist worn electronic devices). Still further, there is less glare while reading display because display is easier to orient perpendicular to sun's rays. In addition, the device should weigh less than conventional devices worn on the wrist, which provides performance improvements because the metabolic cost of carrying weight on wrist and hands is 10 times more costly than on trunk. That is, the importance of light weight device increases as device is worn more distally.

The location of the operation buttons 5, 7, and 9 for the electronic device is also unique. The controls (buttons, dials, switches, etc) should be positioned so the intended fingers and/or thumb can operate them easily. The controls can be located on the exterior surface of the housing 1 or on the interior surface of the housing 1 (the surface in constant contact with the wearer).

While the operation buttons 5, 7, and 9 or other controls are preferably operated by use of the thumb, other methods of operating the electronic device may be used. These include flexing or extending the finger(s), thumb, hand, and/or wrist to change the mode etc. straightening the finger to which the housing is attached activates a pressure switch inside the housing that elicits a specified function, voice activation, and orientation- translating/rotating the electronic device in 3D space can elicit the desired function. Still further, physiological responses—for instance, a change of heart rate, breathing rate, sweat composition, electrical impedance, temperature, etc.—could change the function in a desired way.

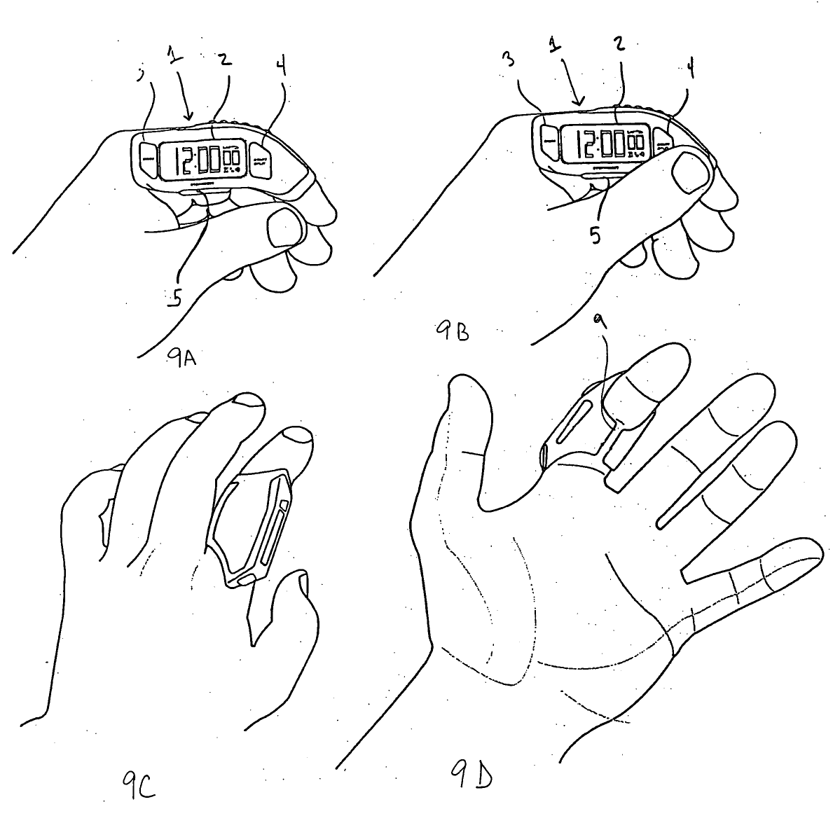

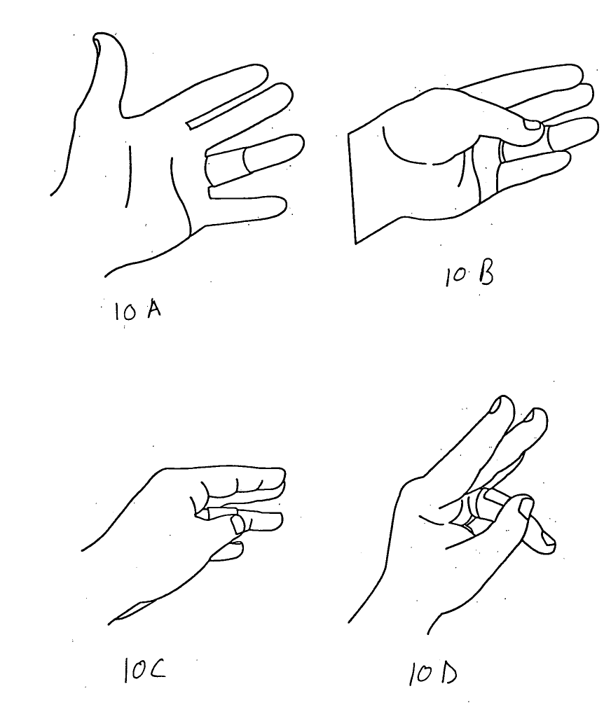

FIGS. 9A-9D show an embodiment of the present invention implemented as a finger watch. The watch 1 includes a display 2, and three selector buttons 3, 4, and 5. The display 2 is used to display the operational features of the watch 1 as will be described further with respect to exemplary FIG. 12 below. The selector buttons 3, 4 and 5 are buttons that can be depressed by the user of the watch 1 in order to operate the various features available on the watch. As seen in FIGS. 9A and 9B, the mode buttons 3, 4 and 5 are uniquely placed to Decrease chances of mistakenly pressing a button, and provide ergonomic advantages, particularly with the placement of the buttons to the right and left of the display 2.

As also seen in FIGS. 9A and 9B, the housing of the watch includes a bent or contoured tubular interior shape. This shape ensures that the housing of the electronic device of FIGS. 9A and 9B is only worn on medial aspect of finger, which optimizes viewing angle. As noted above, the bent tubular shape decreases the chance that the watch will rotate around your finger when the user presses one of the operation buttons 2, 3 or 4. As seen in FIG. 9D, one embodiment of the invention may include a portion 9 where the sleeve of the device is discontinuous. Moreover, the device of FIG. 1 takes advantage of the truncated conical (finger becomes smaller as you move distally) shape of the finger to fit a broader range of people. This allows one watch size to fit an ectomorphic man's proximal finger segment & a mesomorphic man's intermediate finger segment, for example.

Key features of one embodiment of the finger watch shown in FIGS. 9A-9D are that the housing is intended specifically for running activities, and the electronic device measures time. The wearer can operate the device by pressing the buttons with his or her thumb on the same hand they are wearing the housing. Moreover, the cross sectional shape of the housing interior prevents the device from rotating around the long axis of the finger, and the portion of the housing located on the palmar (anterior) surface of the finger does not cross the joint area. This allows the finger to flex in a natural and comfortable way.

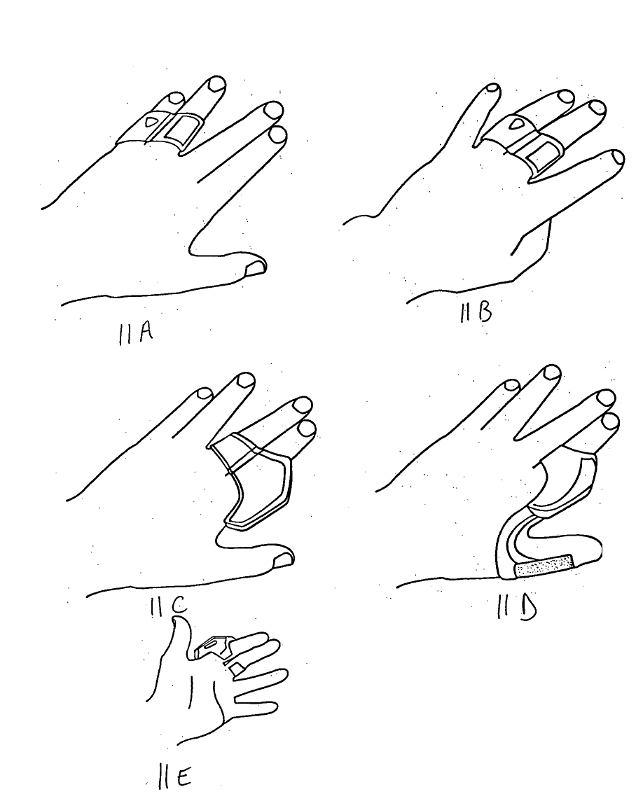

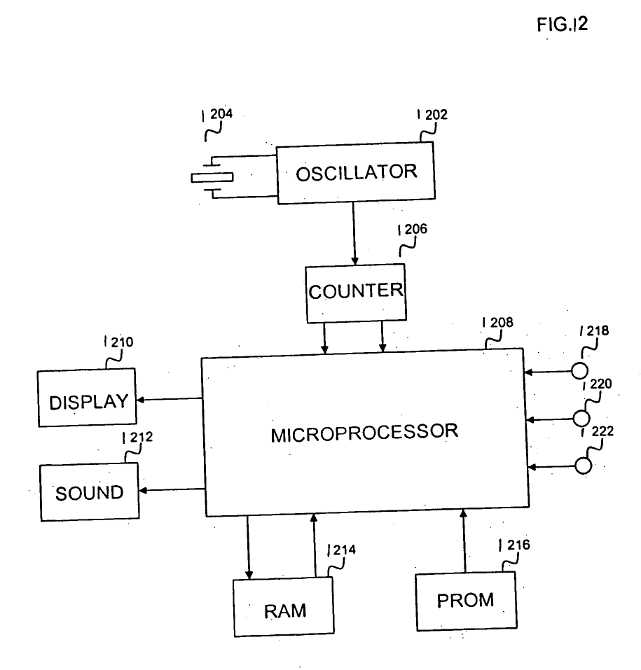

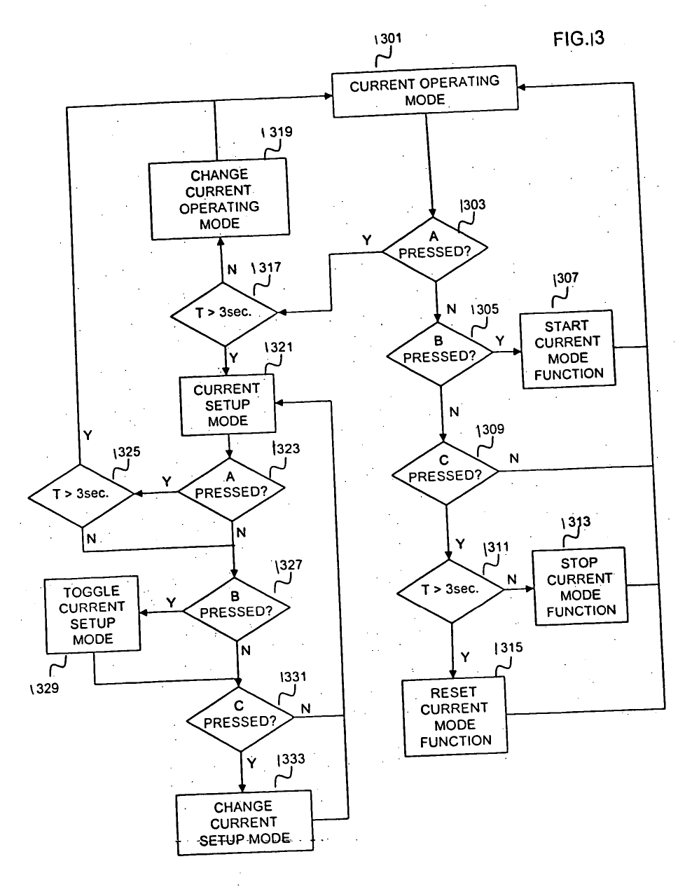

While FIGS. 8 and 9 show the electronic device worn on the index finger, according to the present invention, the device may be worn on any segment of any finger or thumb. FIGS. 10A-10D show an embodiment of the present invention worn on the user's ring finger. In addition, the device may be worn on any segment or combination of segments of any finger or thumb. Indeed, the device according to the present invention may be worn anywhere on a hand, finger, or thumb such that the thumb, or one or more fingers, can activate the controls, or in a manner that allows movements at the wrist to activate the controls. Still further, the device can be worn anywhere on hand, finger, or thumb such that movement of the finger(s) or thumb, that is wearing the housing, can activate the controls. As noted above, the movements used to activate the controls can include: flexion, extension, internal rotation, external rotation, abduction, adduction or any combination thereof, singularly or in combination or in series. In addition to single finger use, the present invention may be implemented as a device worn on any combination of adjacent fingers and the thumb as shown in FIGS. 11A-11E.

FIG. 12 is an electronic block diagram showing the architecture of an electronic device in accordance with one embodiment of the present invention. As seen in this figure, the electronic device includes an oscillator 1202, a crystal 1204 and a counter 1206 that provides inputs to a microprocessor 1208. The microprocessor 1208 is also coupled to a display 1210, a sound device 1212, a random access memory (RAM) 1214 a programmable random access memory (PROM) 1216 and input switches 1218, 1220, and 1222. The time base oscillator 1202 and associated crystal 1204 produces a sequence of pulses driving the counter 1206 to provide an output frequency to the microprocessor 1208. The counter 1206 is preferably a frequency dividing counter that provides at least two output bit streams that are read into the microprocessor 1206, which uses the inputs from the counter to update software counters kept in random access memory 1214 (RAM) that control all timing functions, for example. The software program controlling the microprocessor 1208 is contained in a programmable read only memory 1216 (PROM). A display 1210 contains a memory, address logic, display drivers, and optoelectronics for display of the characters and other symbols, preferably in the form of binary pixels. The device also contains a sound circuit 1212 having an auditory amplifier, speaker and any other control logic and circuitry appropriate for providing audio, such as a beeping alarm. Selector buttons 1218, 1220, and 1222, when pressed by the user, transmit a signal to the microprocessor.

While not shown in FIG. 12, the electronic device may include a battery as a power source. In one embodiment, the watch uses a CR1025 3V button cell, which in normal circumstances will be good for years. However, the battery life will vary due to shelf time and the frequency the EL backlight (described below), alarm and hourly chime are used. Other potential power sources include rechargeable battery/recharging system for watch, solar (or other light source) cells on the housing, or subconscious motion activates charging like Seiko Kinetic (Registered Trademark). Conscious motion can also activate charging—e.g. repeatedly flexing a piezo-electric portion of the housing. See http://www.seikowatches.com/collection/html/index.html the entire contents of which as of the date of the filing of this application is incorporated herein by reference.

It is to be understood that the system in FIG. 12 is for exemplary purposes only, as many variations of the specific hardware and software used to implement the present invention will be readily apparent to one having ordinary skill in the art. For example, the functionality of the counter 1202 and oscillator 1206 may be combined in a single device. Examples of digital watches are disclosed in U.S. Pat. Nos. 5,477,508, 4,320,478, and 4,120,148, each of which is incorporated herein by reference.

FIG. 13 is a flow chart showing a general operation of an electronic device having the custom mode setting feature in accordance with an embodiment of the present invention. The process shown in FIG. 13 is implemented on an electronic device having three input buttons such as that shown in FIGS. 1-9. The input buttons are generically referred to as “A,” “B,” and “C” in the flowchart. As seen in FIG. 13, the electronic device is in a current operating mode as shown by step 1301. The current operating mode is the currently selected one of the plurality of operating modes provided by the electronic device. In the embodiment shown, sequential monitoring of whether one of the mode buttons is depressed is accomplished by decision block 1303, which monitors the A button, decision block 1305, which monitors the B button, and decision block 1307, which monitors the C button. Where the A button is pressed, a process flow for changing and/or setting up an operating mode is initiated, as seen in decision block 1303. The process flow relating to pressing button A in decision block 1303 will be described below. Where button B is depressed, the process continues to step 1307, where the electronic device starts a current mode operation. Where the electronic device is a watch, the current mode operation may be a “stopwatch” function, which is started in step 1307. That is, pressing button B when the device is in stopwatch mode will start the timer of the stopwatch. Once the current mode function is started in step 1307, the process returns to step 1301 where monitoring of the input buttons in the normal operation sequence resumes.

In decision block 1309, if button C is not depressed, the process returns to step 1, where monitoring of the input buttons resumes. Where button C is depressed, the process continues with decision block 1311. In step 1311, a determination is made whether the C button is depressed and quickly released, or depressed and held for more than three seconds. Where button C is not held for more than three seconds, the process flows to step 1313 where the current mode function, such as the stopwatch started with button B as described above, is stopped. Once the current mode function is stopped in step 1313, the process returns to step 1301 where monitoring of the input buttons resumes. Where button C is depressed for more than three seconds, the current mode function is reset as shown in step 1315. Continuing with the timer example introduced above, step 1315 may include resetting the timer to zero seconds. Once the current mode function is reset in step 1315, the process returns to step 1301 where monitoring of the input buttons resumes.

Turning again to decision block 1303, where button A is depressed by the user, the process continues with the electronic device determining whether the button A is depressed and quickly released, or depressed and held for more than three seconds. Where button A is not held for more than three seconds, the process flows to step 1319 where the current operating mode is changed to another one of the multiple operating modes offered by the electronic device. For example, if the user wishes to change from a stopwatch function to an alarm function, the user would depress and quickly release button A. Changing of the current operating mode may take place in sequence or by display of a menu on the monitor of the device. Moreover, because the operating modes are fixed in number, in a preferred embodiment the process is configured to cycle through all operating modes and then restart at the first operating mode. That is, by pressing the A button in rapid succession, the user can scroll through the available operating modes until the desired mode is found. Once the current operating mode is changed in step 1319, the process returns to step 1301 where monitoring of the input buttons resumes.

Where button A is depressed and held for more than three seconds in step 1317, the process continues to step 1321, where a current setup mode is displayed so that the multiple modes of the electronic device can be customized. For example, where the electronic device includes five modes of operation and the user only wishes to use three desired modes, the user presses and holds button A to enter a custom mode setting sequence where the user can operate buttons B and C to select custom modes.

As seen in FIG. 13, once the user enters the custom mode sequence in step 1323, buttons A, B, and C are monitored in the custom mode sequence to determine if they have been depressed as shown by decision blocks 1323, 1327, and 1331. Where button A is depressed, the process continues with decision block 1325, where determination is made whether button A was released or held for more than three seconds. Where button A was held by the user for more than three seconds, the process exits the custom mode setup sequence and returns to the current operating mode in step 1301, where the buttons are again monitored in the regular operation mode sequence of steps 1303 -1315. If in the custom mode sequence begun in step 1321, the A button is not pressed or inadvertently pressed and quickly released, the process remains in the custom mode setting sequence, and monitoring of the input buttons in this sequence continues. Where button B is determined to be pressed in decision block 1327, the current setup mode is toggled on or off as shown in step 1329. Thus, if the user wishes to disable the current setup mode and exclude this mode from the normal operating modes of the electronic device, then the user toggles the current setup mode to off by depressing button B of the electronic device.

In decision block 1331, determination is made whether button C is pressed by the user. If button C is not pressed, then the process returns to step 1321, where the buttons are monitored in the custom mode setup sequence. Where button C is pressed, the process continues with step 1333, where the current setup mode is changed to another of the available modes provided by the electronic device. Changing of the available modes may take place in sequence or by display of a menu on the monitor of the device. Moreover, because the available modes are fixed in number, in a preferred embodiment the process is configured to cycle through all available modes and then restart at the first available mode setting. That is, by repeatedly pressing button C in the current setup mode sequence, the user can scroll through the available modes until a particular mode is found.

A preferred embodiment of the invention would work in conjunction with multifunction watches, such as in a 3-button watching having:

Button A: Mode/Customize Subset: user presses once to change mode, and presses and holds for 3 seconds to customize subset.

Button B: user presses to start a function while in a mode, and presses to toggle a mode ON/OFF while customizing the subset.

Button C: user presses to stop a function while in a mode, and presses and holds for 3 seconds to reset a function while in a mode. User also presses to cycle to the next mode for Activation/Deactivation while customizing the subset.

With this configuration, if the watch has 6 modes I, II, III, IV, V and VI, the custom mode feature may be accomplished as follows:

1. Initially each press of Button A will cycle one step through the list of 6 modes above, changing the device function accordingly.

2. Then the user enters Customize Subset by pressing and holding Button A.

3. The user cycles through mode I, leaving it toggled to ON.

4. The user cycles to each of the modes II, III, & IV, toggling them to OFF.

5. The user cycles to mode V & leaves it toggled to ON.

6. The user cycles to mode VI and toggles it to OFF.

7. The Customized subset now consists only of modes I and V.

8. Pressing Button A will now cycle only between modes I & V until the subset is customized again.

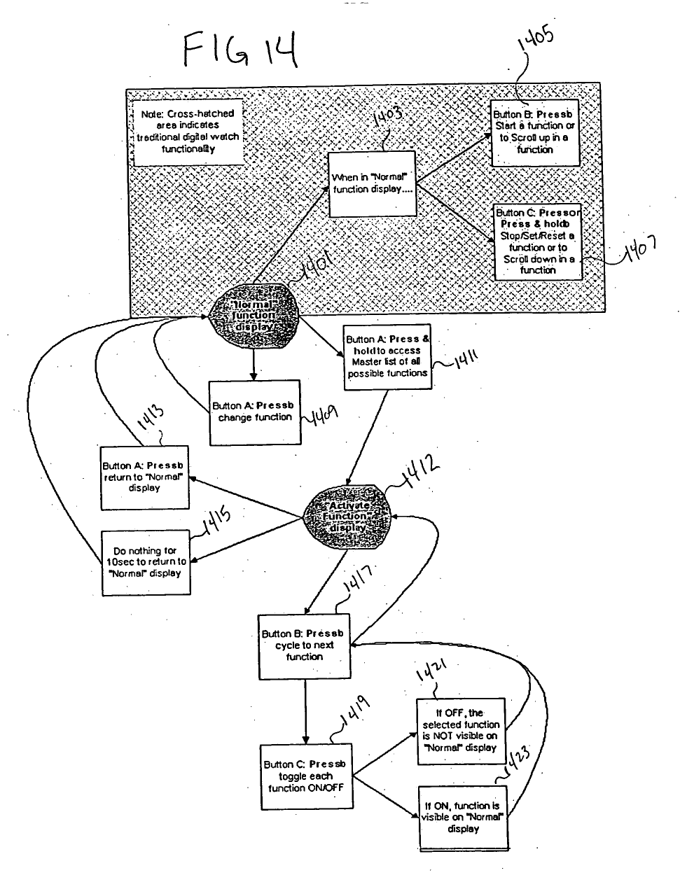

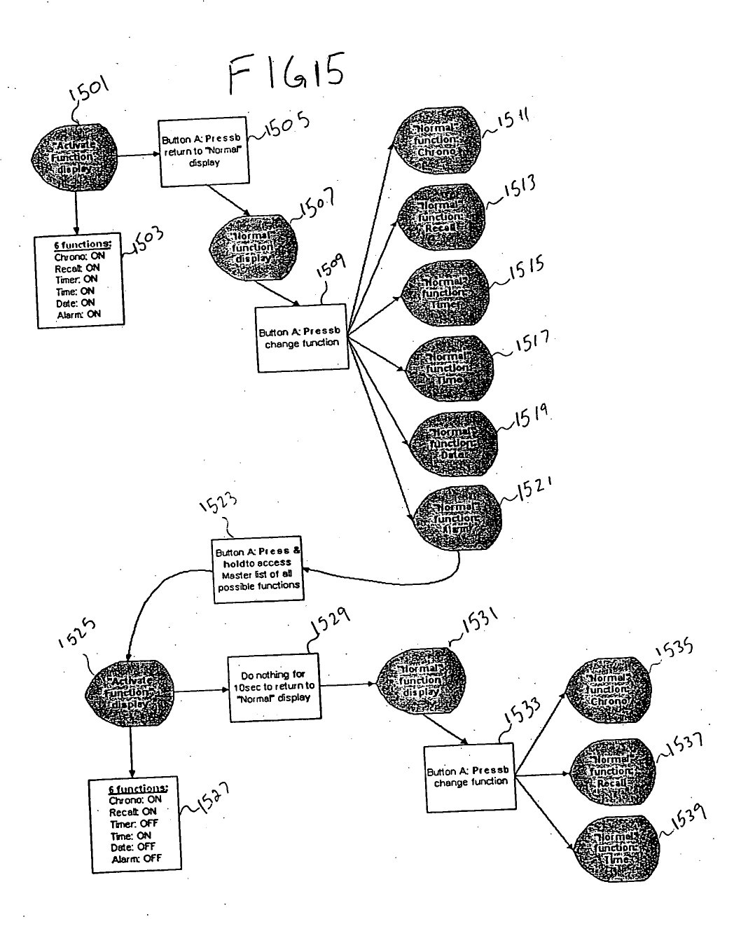

FIG. 14 is a flow chart showing a conventional mode operation process for a digital watch in comparison to a process for setting custom modes in accordance with an embodiment of the present invention. As seen in this figure, the cross hatched area of the flow chart indicates the portion of the flow chart generally provided by conventional digital watches. In the area, the watch provides a “normal” function display as shown by display function 1401. When in this display (step 1403) pressing button B allows the user to start or scroll up in a function in step 1405, and button C allows stop/set/reset or scroll down in a function as shown in step 1407. When button A is pressed in the normal function display, the function is changed as shown by step 1409.

In the embodiment shown in FIG. 14, the inventive process displays a master list of all possible functions in the custom mode setting sequence when button A is pressed and held for a period of time as shown by 1411. This is the “active function” display shown by 1412. The user can manually exit the active function display by pressing button A as seen in step 1413. In addition, in step 1415 the process automatically exits a custom mode setting sequence and active function display when the user does not provide input for ten seconds. Where button B is pressed in step 1417, the active function display cycles to the next function. With each function displayed, the user can toggle the function on or off as shown by step 1419. If the function is toggled “off,” the function will not be visible in the normal display mode as shown by step 1421. However, if toggled “on,” the function will be visible in normal display mode as seen in step 1423. That is, in the embodiment of FIG. 14, each of the modes or functions that are toggled off will be removed from the display of the digital watch.

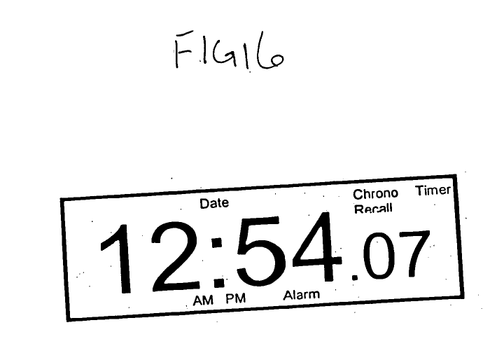

FIG. 15 is a process flow diagram showing the custom mode setting feature of the present invention according to another embodiment of the present invention. As seen in FIG. 15, the embodiment of that figure utilizes three input buttons for providing custom mode setting of Chronograph, 50-lap Recall, Countdown Timer (including a repeat function), Time, Date, Alarm, and EL backlight features. Initially in the activate function display 1501, all six functions (chrono, recall, timer, time, date and alarm) are toggled in the “on,” position as shown by step 1503. Therefore, when button A is pressed to return to the normal display as in step 1505, the normal fuhction display 1507 enables the user to cycle through all six functions by pressing button A as shown by step 1509. That is, repeatedly pressing button A in step 1509, causes the normal function display to display chrono 1511, recall 1513, timer 1515, time 1517, date 1519, and alarm 1521. When the user wishes to customize the mode features, button A is pressed and held to access a master list of all possible fuinctions, as shown in 1523. In the activate function display 1525, in an embodiment of FIG. 15, the user operates the mode buttons to toggle off the timer, date, and alarm modes as shown in step 1527. Then, the user does nothing for 10 seconds as shown in step 1529 and the display returns to the normal display 1531. Then, by pressing button A to change the finctions in step 1533, the user can only cycle through the normal fuinction chrono 1535, normal function recall 1537, and normal function time 1539, which were toggled to the “on” position in the activate function display.

A more specific example of the present invention will now be described. A digital watch implementing the present invention may be implemented as the configuration of FIGS. 1-2 and may include the following modes:

1/100 sec Chronograph

50-lap Recall

Countdown Timer (including a repeat function)

Time

Alarm

Date

EL backlight

In addition, the watch may have the following 3 control buttons:

MODE

START/LAP

STOP/RESET

With the configuration of this specific embodiment, the user can choose the normal operating modes as follows:

1. Press & hold the MODE button for 2 seconds (in any display mode). The display will show CUS.

2. Press the START/LAP button to cycle through all the available normal modes; EL, Alarm, Date, Time, Timer, Recall, Chrono, and Beep. These modes are all defaulted to be ON.

3. Press the STOP/RESET button to toggle any of these normal modes ON or OFF

4. Press the MODE button (or press nothing for 10 seconds) to return to normal operation mode display.

5. When the watch returns to normal mode display, only the modes toggled to ON will be available by pressing the MODE button.

However, if no functions are toggled ON, the watch display may “freeze” requiring the user to follow the directions HOW TO RESET THE WATCH, described below, to correct this problem.

Thus, in this specific embodiment, the watch can display any of the six normal operation modes; CHR (chronograph), REC (recall), TMR (timer), TIME, DATE, and ALM (alarm). As seen in FIG. 16, the display includes a large time display portion as well as smaller mode indicator displays. In a preferred embodiment, only those modes that are selected for operation using the custom mode setup feature are displayed on the display of the watch. To change the display from one mode to the next, the user presses the MODE button once. The mode description will appear briefly before the mode is activated.

The following is a description of how to use the different modes of operation according to an embodiment of the present invention. Any or all of the modes described below can be implemented with any of the embodiments of the electronic device described herein. Moreover, the described modes may be combined with other modes not specifically described herein:

How to Use the Chronograph

To time a single event the user performs the following steps:

1. Select the CHRONO mode by pressing the MODE button.

2. Press the START/LAP button to start.

3. Press the STOP/RESET button to stop.

4. Press & hold the STOP/RESET button for two seconds to reset the chronograph.

To use the lap feature the user performs the following steps:

1. Select the CHRONO mode by pressing the MODE button.

2. Press the START/LAP button to start.

3. Press the START/LAP button again to start each new lap (and end the current lap).

The last lap time and the last lap number will be displayed alternatively every 3 seconds for a period of 12 seconds.

After 12 seconds, the display will alternate every 3 seconds, showing the cumulative time & the current lap time. A small “LAP” icon above the last two digits indicates the current lap time. No “LAP” icon indicates the cumulative time.

4. Press the STOP/RESET button to stop.

5. Press & hold the STOP/RESET button for two seconds to reset the chronograph.

The chronograph counts from 0 hour, 0 minute and 00.00 second to 23 hours, 59 minutes and 59.99 seconds. When the maximum is reached, the time will be entered as a lap automatically.

How to Use the Recall Mode

1. Select the RECALL mode by pressing the MODE button.

2. The display will alternate showing the following:

On the 1^{st} lap, the lap number & lap time.

On additional laps, the lap number, lap time and cumulative time. A small “LAP” icon above the last two digits indicates the current lap time. No “LAP” icon indicates the cumulative time. The cumulative time equals the total time after the final lap.

3. Press the START/LAP button to scroll to the next lap.

4. Press the STOP/RESET button to scroll to the previous lap.

In addition, Recall Mode will display two short dashed lines & the Recall icon if there are no laps in memory.

How to Use the Timer

To set the countdown time the user performs the following steps:

1. Select the TMR mode by pressing the MODE button.

2. If the timer is running, press STOP/RESET to stop.

3. Press and hold the STOP/RESET button. The hour digits will blink.

4. Additional presses of the STOP/RESET button will make the minutes or seconds digits blink, or REP blink. REP allows you to choose whether the timer repeats the countdown or stops after reaching zero.

5. Press the START/LAP button to set the blinking digits or to toggle the Repeat timer feature ON or OFF.

6. Press the MODE button to confirm.

To start a countdown while in Timer mode the user performs the following steps:

1. Press the START/LAP button.

2. Warning beeps will be emitted 3 seconds prior to reaching zero.

3. The beeps change pitch when the countdown reaches zero.

4. Press any button to mute the beeping.

5. The timer will be reset to the countdown time after 0.5 seconds.

6. Depending on your choice for the REPEAT option, the timer will stop or begin counting again.

In addition, the user can set the timer from 0 hour, 00 minute and 00 second to 23 hours, 59 minutes and 59 seconds.

How to Set the Time

1. Select the TIME mode by pressing the MODE button.

2. Hold down the STOP/RESET button for two seconds. The hour digits will blink.

3. Additional presses of the STOP/RESET button will make the minutes or seconds digits blink, make all the digits blink (for setting AM or PM), or 12/24-H blink

4. Use the START/LAP button to set the currently blinking item.

Pressing the START/LAP button when the seconds digits are blinking will reset the digits to 00. This will increase the time by one minute if the original setting is at 30 seconds or more.

Press the START/LAP button once to increase one unit or hold the button to speed up the process.

A small “PM” icon will indicate times between noon and midnight. No “PM” icon indicates morning times.

5. Press the MODE button to confirm and return to normal display.

6. The user can retain the set values and exit the setting procedure at any time by pressing the MODE button or by not pressing any button for 10 seconds.

How to Set and Use the alarm

To set the Alarm the user performs the following steps:

1. Select the ALARM mode by pressing the MODE button.

2. Hold down the STOP/RESET button for two seconds. The hour digits will blink. Press again to make the minutes digits blink. Pressing one more times will make all the digits blink (for setting AM or PM). A small “PM” icon will indicate times between noon and midnight. No “PM” icon indicates morning times.

3. Use the START/LAP button to adjust the blinking digits.

4. Press the MODE button to confirm and exit.

To use the Alarm the user performs the following steps:

1. To activate the Alarm, press the START/LAP button while the daily alarm is displayed. The ALARM ON indicator will light up. Press the button a second time to deactivate the alarm.

2. To stop the alarm alert, press any button. In one embodiment, the Alarm is intended as an audible reminder for runners. It may not be loud enough to wake the user in the morning.

How to Set the Date

1. Select the DATE mode by pressing the MODE button.

2. Hold down the STOP/RESET button for two seconds. The month digits will blink.

3. Additional presses of the STOP/RESET button will make the date or year digits blink.

4. Use the START/LAP button to set the blinking digits.

5. Press the MODE button to confirm and exit. The entered date will be checked automatically for validity. Should it be invalid, the next valid date will be adopted. In one embodiment, the user may enter any year from 2000 to 2049.

How to Use the El Backlight

If EL mode is toggled ON in the Custom Mode (for example, for night use), the EL backlight will be switched on for 5 seconds when any button is pressed. If EL mode is toggled OFF in the Custom Mode (day use), the EL backlight will only be switched on for 5 seconds when pressing & holding the Mode button to enter the Custom Mode.

How to Reset the Watch

For a situation where the display “freezes”, as noted above, the user can reset the watch. To reset the watch, the user holds down the MODE, START/LAP and STOP/RESET buttons simultaneously for two seconds. The LCD will light up briefly and factory settings will be adopted. This procedure is useful when you want to erase all current settings. After resetting the watch, the user will need to reset the time, date, etc.

Thus, the present inventors have discovered an advantageous mechanism to control personal electronic devices having more than one mode of operation. The invention allows the user to activate or deactivate a subset of the device's modes of operation. The invention allows the user to create a subset of modes that the “mode” button controls. The “mode” button then sequentially changes from one mode to the next within this subset. For example, the user can create a subset consisting only of modes A, D, & F. The “mode” button will then simply sequentially change from A to D to F to A, etc until such time as the user changes the subset of active modes.

It is to be understood that the system in FIG. 12 is for exemplary purposes only, as many variations of the specific hardware and software used to implement the present invention will be readily apparent to one having ordinary skill in the art. For example, the functionality of the counter 1202 and oscillator 1206 may be combined in a single device. Examples of digital watches are disclosed in U.S. Pat. Nos. 5,477,508, 4,320,478, and 4,120,148, each of which is incorporated herein by reference.

While the housing 1 and electronic device have been described above primarily in relation to running, the housing provides an advantageous method for using electronic devices during various sport activities. Examples include, but are not limited to Athletics, such as track and field. The present invention can be used in virtually every event in track and field event except perhaps hammer throw and pole vault; these two events require the athlete to use both hands on a sport implement. The remaining everits (running, jumping, & throwing implements not requiring 2 hands) generally do not have this constraint. Traditional electronic devices, such as a wristwatch, are worn on one wrist, but must be operated with the fingers on the contralateral (opposite) hand. This required motion interferes with arguably every sport movement in track and field. The present invention may also be used in swimming (lap timing), archery (time from release to target impact), racquet sports, fishing, hunting, sailing, rock climbing, etc. Moreover, those performing exercises commonly conducted at health clubs, such as strength training, aerobics, dance, martial arts etc, may use the present invention.

The present invention provides an advantageous method for using electronic devices during various non-sport activities as well. Examples include, but are not limited to: work activities requiring constant movements of one of a person's hands, but not the other (for example, writing, typing, sewing, talking on the phone, etc. In one example, a typist can check the time or other parameters on the display without removing hands from keyboard. The present invention may also have medical applications such as for a stroke victim with control of only one side of their body or an amputee with only one hand could operate various electronic devices using a housing according to the present invention. Any activities for people with Wrist-related Medical Problems such as circulation and nerve damage, carpel tunnel syndrome, and other medical problems caused or exacerbated by wearing a wrist strap may benefit from the present invention. The invention may also have military applications; using both hands to operate a watch requires letting go of the weapon, increasing the soldier's risk of injury. Single-handed operation is more secure and potentially life-saving.

Other embodiments of the present invention may use different housings for different sports; one such housing could incorporate a specialized glove or the ability to attach to ordinary gloves, thus providing a means of using the electronic device for activities such as snowboarding. Moreover, Functional Modularity may be implemented, wherein different fingers or combination of fingers or parts of the hand could wear additional devices i.e. flashlight on index finger, a watch on the thumb, a shared power source on the back of the hand (separate claim). In one embodiment, the device could provide control for advanced footwear and clothing; for example, remote control of various actuators or sensors on other parts of the body (i.e., away from the hands). Another example is an actuator in the sole of a shoe that makes the sole softer or harder depending on ground surface is activated by pushing buttons on the housing.

Obviously, numerous modifications and variations of the present invention are possible in light of the above teachings. It is therefore to be understood that within the scope of the appended claims, the invention may be practiced otherwise than as specifically described herein.

1. A housing for an electronics module, comprising
a sleeve portion having an interior bend configured to receive a knuckle on a wearer's finger such that the housing can be securely mounted on the wearer's finger;
a cavity configured to receive an electronics module therein; and
a control access configured to align with controls of the electronics module such that the wearer can operate the electronics module when contained in said recess.

2. The housing of claim 1, wherein said interior bend is configured such that the housing substantially resists rotational movement when worn on the wearer's finger.

3. The housing of claim 1, wherein said recess is oriented in relation to the interior bend of the sleeve such that the electronics module is mounted on a side portion of the wearer's finger when contained in said cavity and the housing is worn on the wearer's finger.

4. The housing of claim 1, wherein said cavity has a substantially similar shape as said electronics module to be received in said cavity.

5. The housing of claim 1, wherein said cavity includes at least one opening that is smaller than a periphery of the electronics module such that the electronics module is held securely in the sleeve when the electronics module is forced into the cavity.

6. The housing of claim 1, wherein said cavity includes at least one opening configured to align with a display of said electronics module such that the display is viewable when the module is contained in said housing.

7. The housing of claim 6, wherein said at least one opening comprises a rectangular opening.

8. The housing of claim 7, wherein said control access comprises three switch covers integrally formed in said housing and configured to align with depress switches of the electronics module, said switch covers being positioned adjacent to respective right, left and bottom sides of said rectangular opening.

9. The housing of claim 8, wherein a length of each of said switch covers is smaller than a length of the respective side that the switch cover is positioned adjacent to.

10. The housing of claim 1, wherein said control access comprises at least one switch cover configured to align with a switch on said electronics module when said module is contained in said housing.

11. The housing of claim 1, further comprising an electronics module contained in said housing.

12. The housing of claim 11, wherein said electronics module is configured to perform at least one of measuring, recording, and providing feedback to the wearer of the housing.

13. The housing of claim 11, wherein:
said interior bend is positioned on a top portion of the housing,
said electronics module includes a rectangular display,
said recess includes a rectangular opening configured to align with the rectangular, display contained in said housing, such that the display is viewable through said opening,
said recess is oriented such that a plane of said display is substantially perpendicular to an apex of said interior bend such that the display is viewable on a side portion of the wearer's finger when the housing is mounted on the wearer's finger, and
said control access comprises three switch covers integrally formed in said housing and configured to align with depress switches of the electronics module, said switch covers being positioned adjacent to respective right, left and bottom sides of said rectangular opening such that a user can operate the switch covers with a finger of the hand on which the housing is mounted.

14. The housing of claim 13, wherein when viewing the display face, the dimensions of the housing are:
approximately 58 mm from left tip to right tip,
approximately 22 mm from bottom to top of watch, and
34 mm from the plane of the display to the back of the housing.

15. The housing of claim 11, wherein said electronics module comprises a watch.

16. The housing of claim 1, wherein said housing is configured to be worn on any finger of a wearer's hand.

17. The housing of claim 1, further comprising another sleeve portion configured to receive another finger of the wearer's hand adjacent to the finger received in the sleeve portion having the interior bend.

18. The housing of claim 11, wherein said electronics module comprises:
includes at least a processor and a memory configured to store a plurality of available mode settings for the electronic device; and
an input mechanism configured to provide input commands to said processor, wherein said processor is configured to, based on said input comments, configure said electronics module to provide a custom mode setting for a subset of the plurality of available modes.

19. The housing of claim 18, wherein said processor operates in a current operation mode sequence where the input mechanism is used to initiate functions of a current mode of the electronic device.

20. The housing of claim 18, wherein said processor operates in a custom mode sequence where the input mechanism is used to select said subset of the available modes to be provided in a custom mode setting.

21. A housing for an electronics module, comprising
means for receiving a knuckle on a wearer's finger such that the housing can be securely mounted on the wearer's finger;
means for mounting an electronics module in the housing; and
means for accessing controls of the electronics module such that the wearer can operate the electronics module when contained in said recess.

22. The housing of claim 21, further comprising an electronics module mounted in said housing by way of said means for mounting, said electronics module comprising:
a processor;
means for storing a plurality of mode settings;
means for inputting input commands to said processor, wherein said processor is configured to, based on said input commands, configure the electronic device to provide a custom mode setting for a subset of the plurality of available modes.
